(19) United States
(12) Patent Application Publication
(10) Pub. No.: US 2025/0303618 A1
(43) Pub. Date: Oct. 2, 2025

(54) COMPOSITE SANDWICH STRUCTURE AND METHOD OF MAKING THE SAME

(71) Applicant: Cytec Industries Inc., Princeton, NJ (US)

(72) Inventors: Aurele BRAS, Nottingham (GB); Adam WHYSALL, Derbyshire (GB); SAM NEWTON, Wrexham (GB); Kevin DUPUIS, Pointe-Claire (CA); Alejandro RODRIGUEZ CHACON, Rancho Santa Margarita, CA (US)

(21) Appl. No.: 18/864,580

(22) PCT Filed: May 2, 2023
(86) PCT No.: PCT/US2023/066477

§ 371 Date: Nov. 11, 2024

Related U.S. Application Data
(60) Provisional application No. 63/337,485, filed on May 2, 2022.

(51) Int. Cl. B29C 43/20; B29K 63/00; B29K 105/08; B29K 307/04

(52) U.S. Cl. CPC B29C 43/206; B29K 2063/00; B29K 2105/0881; B29K 2307/04; B29K 2715/003

(57) ABSTRACT

A method for forming a composite sandwich structure by compression molding is disclosed. The method includes: placing a stack of two composite skins (13a, 13b) separated by a non-adherent layer (13c) in a compression molding tool (10); compression molding the stack of composite skins and non-adherent layer while applying heat to the tool, wherein compression molding of the stack is carried out until each composite skin conforms to and adhere to the molding surface adjacent to it but the thermoset resin in each composite skin is not fully cure; opening the compression molding tool, wherein each composite skin remains adhered to the adjacent molding surface; removing the non-adherent layer from the compression molding tool; placing a core layer (14) in the compression molding tool; and compression molding until the core layer is bonded to the composite skins, thereby forming a shaped sandwich structure (15).

The present disclosure relates generally to composite sandwich structures and method of making the same.

### BRIEF DESCRIPTION OF THE DRAWINGS

FIGS. 1-8 illustrate the different stages of a sandwich press forming method according to an embodiment of the present disclosure.

FIG. 9 is a photomicrograph showing a cross-sectional view of a sandwich structure produced according to a traditional method.

FIG. 10 is a photomicrograph showing a cross-sectional view of a sandwich structure produced according an exemplary press forming method of the present disclosure.

### DETAILED DESCRIPTION

Composite sandwich structures having a low-density core sandwiched between two outer skins have been used in applications where weight reduction is an important factor. Typically, the outer skins are thin sheets of fiber-reinforced composite material. Such sandwich structures provide strength and stiffness while minimizing the structures' weight. For certain applications such as aerospace and automotive composite parts, the outer skins usually contain reinforcement fibers impregnated with a thermoset resin. The thermoset resins used for the thermosettable outer skins typically require curing at high temperature (e.g., 120° C.-180° C.).

Traditionally, the composite sandwich structures containing thermosettable outer skins are consolidated and cured using an autoclave or a vacuum-bag-only (VBO) process. Consolidation of the outer skins is required to form a void-free composite material after curing. An autoclave is a pressure vessel capable of applying elevated temperatures and high pressures to form a cured thermoset composite that is void-free, but it uses a lot of energy, is expensive to operate, and limits the size of the products to be processed. In the VBO process, the stack assembly of outer skins and core material is placed on a tool surface and then enclosed by an gas-impervious, flexible membrane (called “vacuum bag”). The volume enclosed by the flexible membrane is evacuated to apply pressure while heating is applied to the stack assembly. The autoclave and vacuum-bag-only (VBO) processes require a long cycle time of a few hours, making such process incompatible with high volume production.

Press forming or compression molding is a faster process for shaping the sandwich structures. During a standard compression molding process, the stack assembly of outer skins and core material is placed in a mold cavity defined by at least two movable mold parts, and the stack assembly is compression molded by the mold parts. In the case of a stack assembly with thermosettable outer skins, pressure and heat are applied during compression molding to enable consolidation and curing of the outer skins in addition to providing sufficient bonding of the outer skins to the core. But such compression molding uses very high pressures to enable processing of sandwich structures within a short period of time. The required high pressures tend to crush or collapse a core material formed of a thermoplastic foam or a honeycomb structure. In order to prevent the core from crushing or collapsing, the compression pressure can be reduced, but low compression pressure results in insufficient consolidation of the skins. If there is an adhesive film applied between the skin and the core material, insufficient consolidation could result in a weak bondline at the interface between the skin and the core material due to the penetration of the resin in the skin into the adhesive film. For a thermoplastic foam core, collapsing can be caused by high temperature applied to the mold. The collapsing of the thermoplastic foam core can be mitigated by lowering the temperature applied during molding, but lower temperature results in a longer cycle time. As a solution to core crushing or collapsing, higher density cores or reinforced cores with higher compressive strength can be used, but such cores bring compromises in terms of higher cost and weight penalty.

Disclosed herein is a method for forming a thermoset composite sandwich structure by compression molding (hereafter referred to as “sandwich press forming” method) at a relatively short cycle time, e.g. less than 1 hour, and at a low cost without collapsing or crushing the core material. Moreover, such sandwich press forming method does not require the use of the high-density cores or reinforced cores with higher compressive strength that are more costly to make and/or that add more weight to the sandwich structure. Other advantages of the sandwich press forming method include optimal skin consolidation and optimal bondline interface between the skin and the core material.

Generally, the sandwich press forming method of the present disclosure includes: placing a stack of two thermosettable composite skins separated by a deformable, non-adherent layer in a compression molding tool; applying compressive pressure and heat to the stack for a time period sufficient to mold and partially cure the skins; removing the non-adherent layer from the tool while leaving the skins adhered to the molding surfaces of the tool; placing a core layer in the tool such that the core layer is between the molding surfaces with the skins adhered thereon; applying compressive pressure and heat to the core layer and the skins in the tool to affect (or cause) molding of the core layer and bonding of the skins to the core. The thermosettable composite skins are composed of reinforcement fibers impregnated or infused with a curable thermoset resin composition. Prior to compression molding of the core layer, a curable adhesive film may be applied to the core layer's surface that will be in contact with each skin in the tool. The curable adhesive film is formed from a curable resin containing one or more thermoset resin(s) and a curing agent. During the second compression molding in which the core layer is compression molded, the application of compressive pressure and heat results in full curing of the skins. The entire sandwich press forming method can be carried out in less than one hour, and in some embodiments, less than 30 minutes.

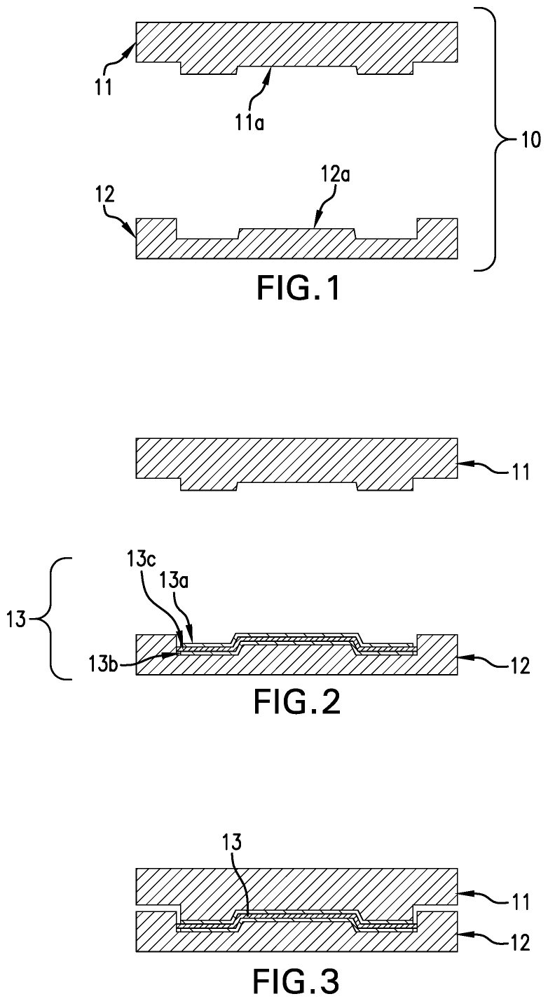

FIGS. 1-8 illustrate the different stages of a sandwich press forming method according to an embodiment of the present disclosure.

Referring to FIG. 1, a compression molding tool 10 having at least a first (upper) mold portion 11 and a second (lower) mold portion 12 is provided. As shown, the molding tool is in an open position. The first and second mold portions 11 and 12 are movable relative each other, and have opposing molding surfaces 11a and 12a that cooperate to define a mold gap or mold cavity when the compression molding tool is in a closed position. The mold gap or mold cavity is in the shape of the final structure to be molded.

Referring to FIG. 2, the compression molding tool is in the open position, wherein the upper mold portion 11 is moved away from the lower mold portion 12a. A stack 13 of two thermosettable composite skins (13a, 13b) and a deformable, non-adherent layer (13c) is placed on the lower mold portion 12. Each thermosettable composite skin comprises reinforcement fibers impregnated or infused with a curable thermoset resin composition. At this stage, the resin composition in the composite skins is uncured, thus, the composite skins are very tacky and pliable. The non-adherent layer (13c) is arranged between the composite skins (13a, 13b) in the stack 13 to prevent the skins from sticking to each other.

Referring to FIG. 3, the compression molding tool is closed by moving the upper mold portion 11 toward the lower mold portion 12, causing the stack 13 of composite skins and non-adherent layer to be compressed between the molding surfaces of the upper and lower mold portions. Compressive pressure and heat are applied during compression molding for a duration sufficient to cause each composite skin to conform to and adhere to the molding surface adjacent to it but not to fully cure the curable resin composition in the composite skin. At this stage, the composite skins went through minimum consolidation and the resin compositions therein are only partially cured. The expression “partially cured” refers to a material state that is less than 100% degree of cure, but greater than 0%. As an example, the degree of cure of the partially cured resin in the composite skins may be in the range of 30% to 90%. In some embodiments, the degree of cure of the partially cured resin is in the range of 60% to 65%. The compressive pressure applied during compression molding may be in the range of 1,000 kPa to 10,000 kPa. The temperature applied during compression molding may be in the range of 120° C. to 200° C. The duration of the compression molding may be less than 20 minutes. In one embodiment, compression molding is carried out for 7 to 10 minutes at 180° C.

The degree of cure of a thermoset resin can be determined by Differential Scanning Calorimetry (DSC). A thermoset resin composition undergoes an irreversible chemical reaction during curing. As the components in the resin composition cure, heat is evolved by the resin, which is monitored by the DSC instrument. The heat of cure may be used to determine the percent cure of the resin. As an example, the following simple calculation can provide the degree of cure:

$$\% Cure = [ Δ {H}_{uncured} - Δ {H}_{cured} ] / [ Δ {H}_{uncured} ] \times 100 \% .$$

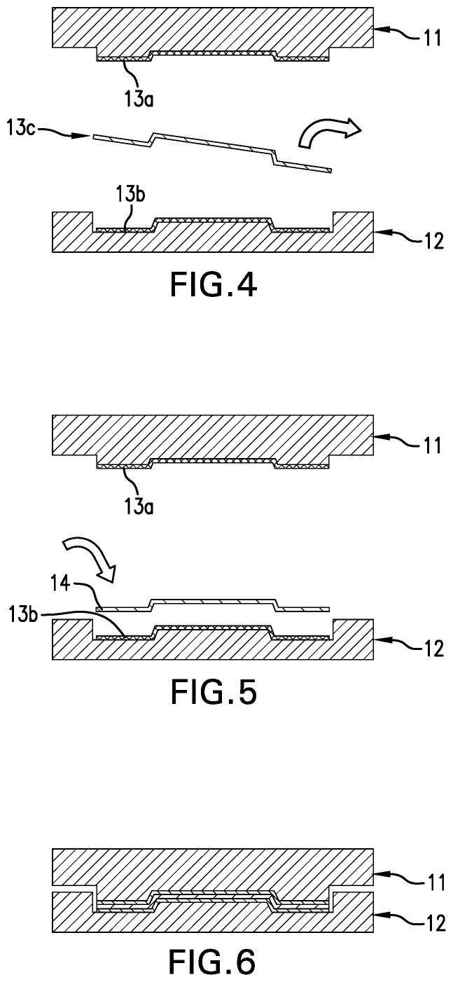

Referring to FIG. 4, the compression molding tool is open by moving the upper mold portion 11 away from the lower mold portion 12, thereby allowing the non-adherent layer 13c to be removed from the tool while the composite skin 13a remains adhered to the molding surface of the upper mold portion 11 and the composite skin 13b remains adhered to the molding surface of the lower mold portion 12.

Referring to FIG. 5, a core layer 14 is placed on the lower mold portion 12 while the tool is in the open position. Optionally, the core layer 14 has a first adhesive film applied on a first surface and a second adhesive film applied on an opposite surface. If present, one of the adhesive film will be in contact with the composite skin 13b on the lower mold portion 12 when the core layer 14 is placed thereon, and the other adhesive film will be in contact with the composite skin 13a on the upper mold portion 11 when the tool is closed. The core layer 14 may be a flat (or substantially flat) layer that can be molded into a desired three-dimensional (3D) configuration or a pre-shaped layer that has the final desired 3D configuration.

Referring to FIG. 6, the compression molding tool is closed to carry out a second compression molding, causing the core layer 14 to be slightly compressed. If the core layer is initially flat, the second compression molding also causes the core layer 14 to conform to the geometry of the mold cavity. Compressive pressure and heat are applied during the second compression molding for a duration sufficient to cause bonding of the core layer (14) to the composite skins (13a, 13b) and full curing of the resin composition in each composite skin. The compressive pressure applied at this stage (FIG. 6) is less than that applied during the initial compression molding of the stack (13) of composite skins and non-adherent layer (FIG. 3). The compressive pressure applied at this stage may be 100 kPa to 1,000 kPa. The temperature applied during the second compression molding may be in the range of 120° C. to 200° C. The duration of the second compression molding may be less than 20 minutes. In one embodiment, the second compression molding is carried out for 8 to 10 minutes at 180° C.

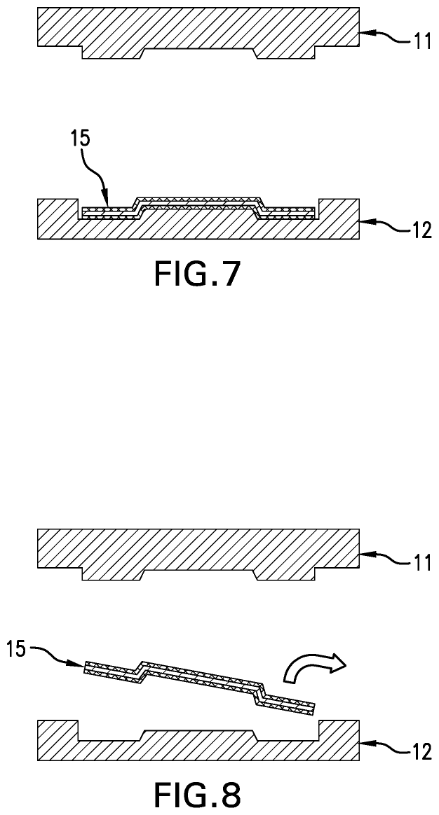

Referring to FIG. 7, the compression molding tool is open, yielding a shaped sandwich structure 15. At FIG. 8, the shaped sandwich structure 15 is removed from the compression molding tool.

### Composite Skins

As discussed above, each thermosettable composite skin comprises reinforcement fibers impregnated or infused with a curable thermoset resin. The term “impregnate” as used in this disclosure refers to the introduction of a curable resin to reinforcement fibers so as to partially or fully encapsulate the fibers with the resin.

In one embodiment, the composite skin is a sheet of composite material, which contains a layer of reinforcement fibers embedded in a layer of curable matrix resin. As used herein, the term “matrix resin” refers to a mass of resin, and the expression “embedded in a matrix resin” means firmly fixed or positioned within a surrounding mass of resin.

The layer of reinforcement fibers may be in the form of unilaterally aligned continuous fibers or a woven fabric. The sheet of composite material is also referred herein as a ply of “prepreg” in the present disclosure. The skin may be a laminate of multiple plies of prepregs, also called a “prepreg layup”.

The curable thermoset resin composition for impregnating/infusing the reinforcement fibers is a hardenable or thermosettable resin containing one or more uncured thermoset resins, which include, but are not limited to, epoxy resins, bismaleimide, vinyl ester resins, cyanate ester resins, isocyanate modified epoxy resins, phenolic resins, furanic resins, benzoxazines, formaldehyde condensate resins (such as with urea, melamine or phenol), polyesters, acrylics, hybrids, blends and combinations thereof. Upon thermal curing by heat application, the thermoset resin composition undergoes crosslinking and becomes irreversibly harden, resulting in a hardened material that can no longer be reshaped by thermoforming (a process that includes heating a material and shaping the thus heated material so as to obtain the desired shaped object).

The term “curing” or “cure” in the present disclosure refers to the hardening of a polymeric material by the chemical cross-linking of the polymer chains. The term “curable” in context of curable composition means that the composition is capable of being subjected to conditions that will render the composition to a hardened or thermoset state.

In preferred embodiments, the thermoset resin composition contains one or more epoxy resins and one or more curing agents and/or catalyst(s).

Suitable epoxy resins include polyglycidyl derivatives of aromatic diamine, aromatic mono primary amines, aminophenols, polyhydric phenols, polyhydric alcohols, polycarboxylic acids. Examples of suitable epoxy resins include polyglycidyl ethers of the bisphenols such as bisphenol A, bisphenol F, bisphenol S and bisphenol K; and polyglycidyl ethers of cresol and phenol based novolacs.

Specific examples are tetraglycidyl derivatives of 4,4′-diaminodiphenylmethane (TGDDM), resorcinol diglycidyl ether, triglycidyl-p-aminophenol, triglycidyl-m-aminophenol, bromobisphenol F diglycidyl ether, tetraglycidyl derivatives of diaminodiphenylmethane, trihydroxyphenyl methane triglycidyl ether, polyglycidylether of phenol-formaldehyde novolac, polyglycidylether of o-cresol novolac or tetraglycidyl ether of tetraphenylethane.

Commercially available epoxy resins suitable for use in the host matrix resin include N,N,N′,N′-tetraglycidyl diamino diphenylmethane (e.g. MY 9663, MY 720, and MY 721 from Huntsman); N,N,N′,N′-tetraglycidyl-bis(4-aminophenyl)-1,4-diiso-propylbenzene (e.g. EPON 1071 from Momentive); N,N,N′,N′-tetraclycidyl-bis(4-amino-3,5-dimethylphenyl)-1,4-diisopropylbenzene, (e.g. EPON 1072 from Momentive); triglycidyl ethers of p-aminophenol (e.g. MY 0510 from Hunstman); triglycidyl ethers of m-aminophenol (e.g. MY 0610 from Hunstman); diglycidyl ethers of bisphenol A based materials such as 2,2-bis(4,4′-dihydroxy phenyl) propane (e.g. DER 661 from Dow, or EPON 828 from Momentive), and Novolac resins, preferably of viscosity 8-20 Pa-s at 25° C.; glycidyl ethers of phenol Novolac resins (e.g. DEN 431 or DEN 438 from Dow); di-cyclopentadiene-based phenolic novolac (e.g. Tactix 556 from Huntsman); diglycidyl 1,2-phthalate (e.g. GLY CEL A-100); diglycidyl derivative of dihydroxy diphenyl methane (Bisphenol F) (e.g. PY 306 from Huntsman). Other epoxy resins include cycloaliphatics such as 3′,4′-epoxycyclohexyl-3,4-epoxycyclohexane carboxylate (e.g. CY 179 from Huntsman).

The addition of curing agent(s) and/or catalyst(s) in the curable matrix resin is optional, but the use of such may increase the cure rate and/or reduce the cure temperatures, if desired. The curing agent is suitably selected from known curing agents, for example, aromatic or aliphatic amines, or guanidine derivatives. An aromatic amine curing agent is preferred, preferably an aromatic amine having at least two amino groups per molecule, and particularly preferable are diaminodiphenyl sulphones, for instance where the amino groups are in the meta- or in the para-positions with respect to the sulphone group. Particular examples are 3,3′- and 4-,4′-diaminodiphenylsulphone (DDS); methylenedianiline; bis(4-amino-3,5-dimethylphenyl)-1,4-diisopropylbenzene; bis(4-aminophenyl)-1,4-diisopropylbenzene; 4,4′methylenebis-(2,6-diethyl)-aniline (MDEA from Lonza); 4,4′methylenebis-(3-chloro, 2,6-diethyl)-aniline (MCDEA from Lonza); 4,4′methylenebis-(2,6-diisopropyl)-aniline (M-DIPA from Lonza); 3,5-diethyl toluene-2,4/2,6-diamine (D-ETDA 80 from Lonza); 4,4′methylenebis-(2-isopropyl-6-methyl)-aniline (M-MIPA from Lonza); 4-chlorophenyl-N,N-dimethyl-urea (e.g. Monuron); 3,4-dichlorophenyl-N,N-dimethyl-urea (e.g. DIURON™) and dicyanodiamide (e.g. AMICURE™ CG 1200 from Pacific Anchor Chemical).

Suitable curing agents also include anhydrides, particularly polycarboxylic anhydrides, such as nadic anhydride, methylnadic anhydride, phthalic anhydride, tetrahydrophthalic anhydride, hexahydrophthalic anhydride, methyltetrahydrophthalic anhydride, endomethylenetetra-hydrophtalic anhydride, and trimellitic anhydride.

The curable thermoset resin composition may contain other additives such as co-monomers, rheology control agents, tackifiers, inorganic or organic fillers, thermoplastic and/or elastomeric polymers as toughening agents, stabilizers, inhibitors, pigments, dyes, flame retardants, reactive diluents, and other additives well known to those skilled in the art for modifying the properties of the matrix resin before or after curing.

Suitable toughening agents for the curable resin composition include but are not limited to homopolymers or copolymers, either alone or in combination, of polyamides, copolyamides, polyimides, aramids, polyketones, polyetherimides (PEI), polyetherketones (PEK), polyetherketoneketone (PEKK), polyetheretherketones (PEEK), polyethersulfones (PES), polyetherethersulfones (PEES), polyesters, polyurethanes, polysulphones, polysulphides, polyphenylene oxide (PPO) and modified PPO, poly(ethylene oxide) (PEO) and polypropylene oxide, polystyrenes, polybutadienes, polyacrylates, polymethacrylates, polyacrylics, polyphenylsulfone, high performance hydrocarbon polymers, liquid crystal polymers, elastomers and segmented elastomers. If present, the total amount of toughening agent(s) in the resin composition is less than 25% (in weight percentage) based on the total weight of the resin composition.

### Core Materials

The core material may be any low-density material, including foam cores and honeycomb structures. The term “foam” as used herein refers to a solidified material in which a large proportion of gas bubbles is dispersed. Generally, a honeycomb structure has a plurality of open cells defined by cell walls. Suitable honeycomb structures are thermoplastic honeycombs.

The foam core may have a density of from 20 to 1000 kg/m³, from 30 to 800 kg/m³, from 35 to 500 kg/m³, from 40 to 300 kg/m³, or from 45 to 200 kg/m³. The density can be measured according to ASTM D1622.

The foam cores may be formed from a foamable composition containing one or more polymers selected from thermoplastic polymers and synthetic polymers. As examples, the foam core may be formed from a foamable composition containing at least one polymer selected from: poly(aryl ether sulfone) (PAES), particularly, polyethersulphone (PES), polyetherethersulphone (PEES), poly(biphenyl ether sulfone) (PPSU); polyamide (PA); polyimide (PI); polyetherimide (PEI); polyvinyl chloride (PVC), polystyrene (PS), polyurethane (PU), polymethacrylamide; styreneacrylonitrile; and copolymers thereof. Generally, PAES polymers having Tg in the range of 201° C. to 290° C. are suitable for the purpose disclosed herein. In some embodiments, the foam core is formed from a foamable composition containing a combination of different thermoplastic polymers.

### Non-Adherent Layer

The non-adherent layer is formed of any material that does not form a permanent, chemical bond with the curable matrix resin in the composite skins. In one embodiment, the non-adherent layer is a thermally deformable layer. As examples, the non-adherent layer is formed of a thermally deformable material selected from: silicone; rubber; hydrophobic fluoropolymers, including polytetrafluoroethylene (PTFE), polyvinylidene fluoride (PVDF), polyvinylfluoride (PVF), fluorinated ethylene-propylene (FEP), polyethylenetetrafluoroethylene (ETFE), polyethylene-chlorotrifluoro-ethylene (ECTFE), perfluoropolyether (PFPE); and combinations thereof. Alternatively, the non-adherent layer contains a rigid material and is pre-shaped so that it has the geometry or 3-D configuration of the core layer in the final shaped sandwich structure. For example, the non-adherent layer may be composed of a metal layer or a composite layer coated on opposite sides with a polymer such as PTFE. The composite layer may be a pre-cured composite material or prepreg composed of fibers, e.g. carbon fibers, embedded in a cured thermoset resin, e.g., cured epoxy. Such composite layer has a low expansion coefficient such that it does not expand during compression molding.

For the purpose disclosed herein, the non-adherent layer may have a thickness of greater than 0 and up to 20 mm.

### EXAMPLES

### Example 1

### Traditional Method

A control panel (Panel #1) was prepared by forming a multilayered assembly composed of a honeycomb core (C1-32-48 from Euro-Composites) with a thickness of 12.6 mm between two composite skins, and positioning the multilayered assembly in a two-part compression molding tool. The tool included two movable molding parts made of steel. Each composite skin was composed of two prepreg plies, each prepreg ply composed of unidirectional carbon fibers impregnated with CYCOM® EP2750 (epoxy resin) from Solvay. The prepreg plies in each skin were stacked in [0/90] configuration. The honeycomb core was coated with an adhesive film, FM® 209-1 from Solvay, on each surface that is in contact with the skin. Compression molding of the multilayered assembly in the tool was carried out for 20 minutes at 3 bar and 180° C., resulting in a cured sandwich structure. The compression molding of Panel #1 is representative of a traditional method.

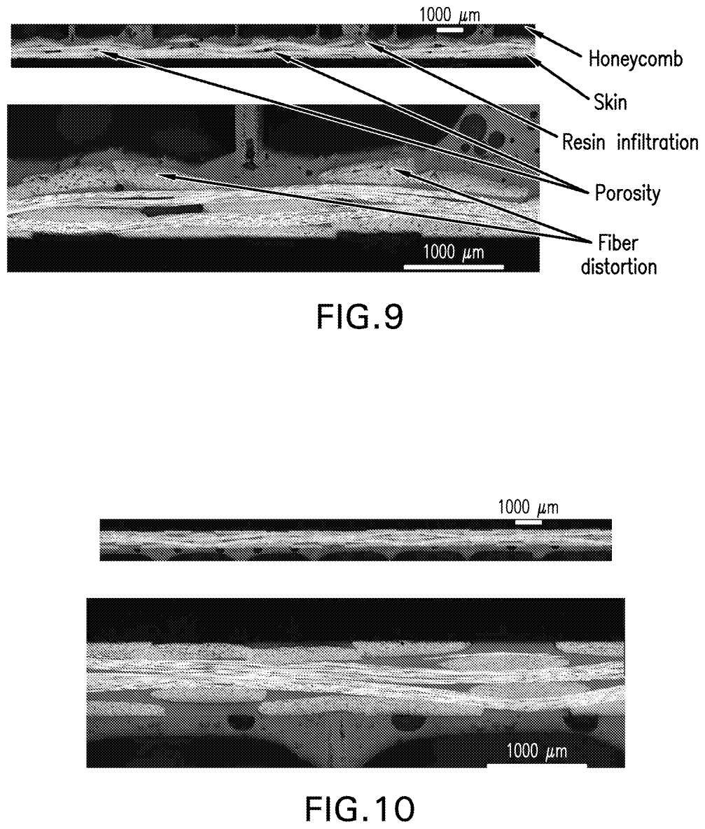

Based on visual observations, the cured Panel #1 contained macro porosities on the skin outer surfaces. Based on microscopic observations through the thickness of Panel #1 (FIG. 9), the following defects were found: porosities in the skins, fiber distortion, no segregation between skin and core due to resin infiltration into the honeycomb core. The lower image of FIG. 9 is an exploded view of the skin in the upper image.

Flat-wise tension test was performed to determine the adhesive failure mode of the cured Panel #1. Test results showed adhesive failure at the bonding interface between the skin and the honeycomb core.

### Example 2

Method with Non-Adherent Layer

A multilayered assembly composed of a non-adherent layer between two composite skins was placed in the two-part compression molding tool described in Example 1. Each composite skin was composed of two prepreg plies as described in Example 1 for Panel #1. The non-adherent layer was a press-formed, pre-cured prepreg with PTFE film applied on each opposing surface. The pre-cured prepreg was formed by molding and curing a prepreg with the same composition as the uncured prepreg plies in the skins.

An initial compression molding of the multilayered assembly with non-adherent layer was carried out for 11 minutes at 30 bar and 180° C. The tool was opened and the non-adherent layer was removed from the tool, leaving the skins adhered to the surfaces of the tool. A honeycomb core (same as that described in Example 1) was placed in the tool. A second compression molding was carried out for 9 minutes at 3 bar and 180° C., resulting in a cured sandwich structure (Panel #2). The total processing time was 20 minutes.

Based on visual observations, the cured Panel #2 contained no porosities on the skin outer surfaces. Based on microscopic observations through the thickness of Panel #2 (FIG. 10), the panel showed no porosities in the skins, no fiber distortion, and distinct segregation between skin and core. The lower image of FIG. 10 is an exploded view of the skin in the upper image.

Flat-wise tension test was performed to determine the adhesive failure mode of the cured Panel #2, and the results showed no adhesive failure at the bonding interface between the skin and the honeycomb core.

1. A method for forming a composite sandwich structure by compression molding, the method comprising:
(a) providing a compression molding tool having at least a first mold portion and a second mold portion, wherein the first and second mold portions have opposing molding surfaces that cooperate to define a mold gap or mold cavity when the compression molding tool is in a closed position;
(b) placing a stack of two composite skins separated by a non-adherent layer on the molding surface of the first or second mold portion when the tool is in an open position, wherein each composite skin comprises reinforcement fibers impregnated or infused with a curable thermoset resin and the non-adherent layer is formed of a thermally deformable material selected from silicone, rubber, hydrophobic fluoropolymers, and combinations thereof;
(c) closing the compression molding tool to compress the stack of composite skins and non-adherent layer between the molding surfaces of the first and second mold portions while applying heat to the tool, wherein compression of the stack is carried out until each composite skin conforms to and adhere to the molding surface adjacent to it but the thermoset resin in said composite skin is not fully cured;
(d) opening the compression molding tool, wherein each composite skin remains adhered to the adjacent molding surface;
(e) removing the non-adherent layer from the compression molding tool;
(f) placing a core layer in the compression molding tool while the tool is in the open position such that the core layer is on one of the composite skins adhered to the molding surfaces;
(g) closing the compression molding tool to compress the core layer between the first and second mold portions while applying heat to the tool, wherein compression of the core layer is carried out until the core layer is bonded to the composite skins and the thermoset resin in each composite skin is fully cured, thereby forming a shaped sandwich structure;
(h) opening the compression molding tool; and
(i) removing the shaped sandwich structure from the compression molding tool.

2. The method of claim 1, wherein the core layer has two opposing surfaces and an adhesive film applied on each of its opposing surfaces, and
wherein one of the adhesive films is facing one of the composite skins when the core layer is placed in the compression molding tool at (f).

3. The method of claim 1, wherein the curable thermoset resin in each composite skin comprises one or more thermoset resin(s), and optionally, a curing agent.

4. The method according to claim 1, wherein compression of the stack of composite skins and non-adherent layer at (c) is carried out for a duration of less than 20 minutes at compressive pressure in the range of 1,000 kPa to 10,000 kPa while applying heat at a temperature in the range of 120° C. to 200° C.

5. The method according to claim 1, wherein heating at (c) is carried out to achieve partially cured composite skins with a degree of cure of greater than 0% and less than 100%.

6. The method according to claim 1, wherein compression of the core layer at (g) is carried out for a duration of less than 20 minutes at a compressive pressure less than that at (c) while applying heat at a temperature in the range of 120° C. to 200° C.

7. The method according to claim 1, wherein the non-adherent layer is formed of a material that does not form a permanent, chemical bond with the curable matrix resin in the composite skins and is a layer that is releasable from the composite skins.

8. The method according to claim 1, wherein the non-adherent layer is formed of a thermally deformable material selected from: polytetrafluoroethylene (PTFE), polyvinylidene fluoride (PVDF), polyvinylfluoride (PVF), fluorinated ethylene-propylene (FEP), polyethylenetetrafluoroethylene (ETFE), polyethylene-chlorotrifluoro-ethylene (ECTFE), perfluoropolyether (PFPE); and combinations thereof.

9. (canceled)

10. The method according to claim 1, wherein the non-adherent layer has a thickness of greater than 0 and up to 20 mm.

11. The method according to claim 1, wherein the core layer comprises a foamed material or a honeycomb structure.

12. The method according to claim 1, wherein the core layer is a foamed material formed from a foamable composition comprising one or more polymers selected from thermoplastic polymers and synthetic polymers.

13. The method according to claim 1, wherein the core layer is formed from a foamable composition comprising one or more thermoplastic polymers.

14. The method according to claim 1, wherein the core layer is a thermoplastic honeycomb structure.

15. The method according to claim 1, wherein each composite skin is a prepreg ply or a multilayered laminate comprising two or more prepreg plies, each prepreg ply comprising reinforcement fibers embedded in a layer of curable matrix resin.

16. The method according to claim 15, wherein the reinforcement fibers in each prepreg ply is in the form of continuous unidirectional fibers or a woven fabric.

17. The method according to claim 15, wherein the reinforcement fibers in each prepreg ply are carbon fibers.
